(19) United States
(12) Patent Application Publication
(10) Pub. No.: US 2026/0119331 A1
(43) Pub. Date: Apr. 30, 2026

(54) DETERMINATION OF OVERLAP OF DATA PROTECTION POLICIES

(71) Applicant: Hewlett Packard Enterprise Development LP, Spring, TX (US)

(72) Inventors: Jaya Santhosh, Bangalore (IN); Aswin Jayaraman, Bangalore (IN); Tejasvi Ranjan, Bangalore (IN); Deven Mahendraray Thaker, Bangalore (IN)

(21) Appl. No.: 19/050,783

(22) Filed: Feb. 11, 2025

(30) Foreign Application Priority Data
Oct. 29, 2024 (IN) 202411082843

(51) Int. Cl. G06F 11/14

(52) U.S. Cl. CPC G06F 11/1453; G06F 2201/80

(57) ABSTRACT

In some examples, a system provides a representation of a storage topology including a plurality of levels of entities that store data in a computing environment, the plurality of levels of entities including a first level including storage volumes and a second level including entities that request storage of data in the storage volumes. A policy repository stores data protection policies for respective entities in the computing environment. The system determines, based on the representation of the storage topology, whether an overlap exists between a first data protection policy and any of the data protection policies in the policy repository. Based on determining that the overlap exists between the first data protection policy and a second data protection policy in the policy repository, the system initiates an action including making a change associated with the first and second data protection policies or making a change associated with an entity in the computing environment.

### BACKGROUND

Data protection can be accomplished by creating a duplicate of primary data stored in a storage system. For example, a snapshot of data or a backup copy of data can be created to use in recovering from loss or corruption of the primary data stored in the storage system.

### BRIEF DESCRIPTION OF THE DRAWINGS

Some implementations of the present disclosure are described with respect to the following figures.

FIG. 1 is a block diagram of an arrangement including a data protection management system, according to some examples.

FIG. 2 to FIG. 9 are block diagrams of different storage topologies, according to various examples.

FIG. 10 is a flow diagram of a process of a protection recommendation engine, according to some examples.

FIG. 11 is a flow diagram of a process of a topology manager and a protection recommendation engine, according to some examples.

FIG. 12 is a block diagram of a storage medium storing machine-readable instructions according to some examples.

FIG. 13 is a block diagram of a system according to some examples.

FIG. 14 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A backup and recovery system may support the protection of data at different levels of a storage topology in a computing environment. For example, a storage volume may be protected by the backup and recovery system, where a storage volume includes a container of data stored in one or more storage devices of a storage system. Protecting the storage volume is accomplished by duplicating data of the storage volume, such as by creating snapshots of the data or maintaining a backup copy of the storage volume. As another example, another entity at a higher level of the storage topology may be protected by the backup and recovery system. The other entity can include a virtual compute entity such as a virtual machine (VM) or a container, an application program, a file share, or any other entity that is able to store data in one or more storage volumes. The foregoing entities are at higher levels of the storage topology than storage volumes. The storage volumes may be part of the lowest level of the storage topology. As an example, protecting data of a VM is accomplished by duplicating data written by the VM. More generally, protecting data of an entity at a higher level of the storage topology than a storage volume is accomplished by duplicating data associated with the resource.

If data protection is specified for entities at multiple levels of the storage topology, data duplication sprawl may occur in which some data items may be duplicated multiple times. Data duplication sprawl may lead to increased storage costs since increased storage capacity has to be provisioned to accommodate the multiple copies of some data items. Further, maintaining multiple copies of data items can lead to an increased amount of input/output (I/O) access of data in the storage system, which can lead to contention for the storage system resulting in increased latency in data access operations. Additionally, making multiple copies of some data items reduces deduplication ratios of the storage system.

In some cases, a storage system may have a limit on the quantity of recovery points (e.g., snapshots, backup copies, etc.) that can be created at any given instant in time. If data protection is provided at multiple levels in the storage topology, then the number of recovery points created may surpass this limit. Once the number of recovery points surpass the limit, subsequent requests to create recovery points may be rejected. In further examples, schedules set by the backup and recovery system may result in the concurrent creation of recovery points for different levels of the storage topology. To create a recovery point, entities may have to be quiesced. Quiescing an entity (e.g., a VM, a container, an application program, etc.) refers to stopping the entity from issuing any further accesses of data so that after the entity has completed any pending data accesses, a recovery point can be created for the entity. Quiescing entities at different levels to create respective recovery points can lead to errors or failures of the entities.

In accordance with some implementations of the present disclosure, a data protection management system can detect overlapping data protection policies for entities at different levels of a storage topology in a computing environment. The overlapping data protection policies may lead to data duplication sprawl. In response to determining, based on a representation of the storage topology, that an overlap exists between a first data protection policy for a first entity at a first level and a second data protection policy for a second entity at a second level of the storage topology, the data protection management system can initiate an action to reduce data duplication sprawl, such as removing one of the first and second data protection policies, suspending the creation of recovery points for certain entities, re-assigning an entity to a different data protection group, moving an entity, or any other action that seeks to prevent the creation of multiple copies of the same data items for entities at different levels.

“Data duplication sprawl” refers to the creation of multiple copies of a given collection of data items due to duplication for entities at different levels of a storage topology. A “storage topology” refers to a hierarchical arrangement (e.g., a tree) including different levels associated with entities that store data. The lowest level of the storage topology includes one or more storage volumes, while higher levels of the storage topology include entities that store data in the storage volume(s), either directly or through one or more intermediate entities.

A “data protection policy” can include a duplication rule specifying what data is to be protected and when the data is to be protected by creating a duplicate of the data. For example, the data protection policy can specify that data of an entity is to be protected at periodic time intervals, or that data of an entity is to be protected in response to specified events.

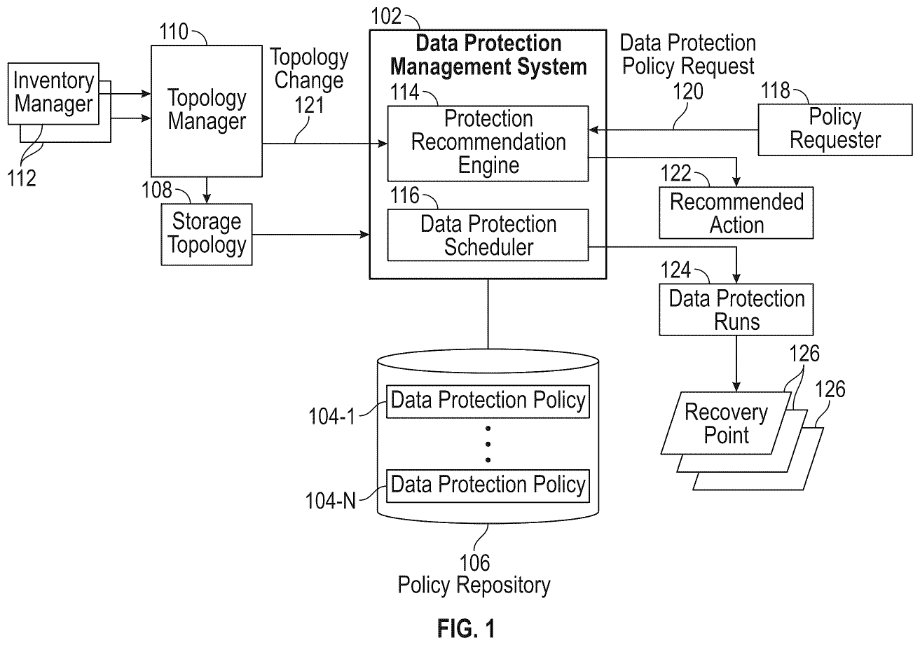

FIG. 1 is a block diagram of an example arrangement that includes a data protection management system 102 that can detect overlapping data protection policies. The data protection management system 102 can be implemented using one or more computers.

Previously created data protection policies 104-1 to 104-N (N≥1) are stored in a policy repository 106, which is contained in one or more storage devices. The data protection policies 104-1 to 104-N are associated with entities at various levels of a storage topology 108.

The storage topology 108 is created by a topology manager 110 that receives information from one or more inventory managers 112 relating to entities in a computing environment that may be deployed. The entities can store data in one or more storage volumes. A representation (e.g., a tree structure or another data structure) of the storage topology 108 can be stored in a data repository contained in one or more storage devices.

An inventory manager is monitor inventories of entities in a computing environment. The inventory manager can detect additions, removals, or changes of the entities. In some examples, an application inventory manager 112 can create a list of application programs (e.g., database programs or other types of application programs) that are deployed in a computing environment. Another inventory manager 112 can create a list of virtual compute entities, such as a VMs or containers, deployed in the computing environment. A further inventory manager 112 can create a list of virtual stores, where a “virtual store” refers to a logical data store that can span one or more storage volumes. Yet another inventory manager 112 can create a list of storage volumes deployed in the computing environment. In further examples, other inventory managers 112 can create lists of other types of entities. A “computing environment” can refer to a data center, a cloud environment, a server environment, or any other type of computing environment.

As an entity capable of storing data is deployed in the computing environment, the corresponding inventory manager 112 can update the respective list of entities. A “list” of entities can include information identifying the entities and relationships of the entities to other entities. For example, a list of VMs can identify the VMs and can include information specifying that the VMs store data in one or more virtual stores. As another example, a list of application programs can identify the application programs and can include information specifying that the application programs execute in respective VMs or containers.

Although some examples refer to use of different inventory managers 112 for different entities, in another example, one inventory manager 112 can be used to provide lists of entities that have been deployed in the computing environment.

As used here, a “manager” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “manager” can refer to a combination of one or more hardware processing circuits and machine-readable instructions (software and/or firmware) executable on the one or more hardware processing circuits

Based on the entities included in various lists of entities provided by the inventory manager 112, the topology manager 110 creates the storage topology 108. The storage topology 108 is represented using a file, an object, or any other data structure.

Although referred to in the singular sense, it is noted that there may be multiple storage topologies produced by the topology manager 110. Each storage topology is identified by a topology identifier (ID), where an identifier (ID) can refer to a name, an alphanumeric string, a number, or any other value.

In a computing environment, a first group of entities may be associated with another, but this first group of entities may not be associated with some other entities of the computing environment. For example, a first group of application programs may be deployed in a first collection of VMs that store data in a first storage volume. There may be a second group of application programs that are deployed in a second collection of VMs (that are distinct from the first collection of VMs) that store data in a second storage volume different from the first storage volume. In this example, a first storage topology can be created by the topology manager 110 to represent the first group of application programs, the first collection of VMs, and the first storage volume. A second storage topology can be created by the topology manager 110 to represent the second group of application programs, the second collection of VMs, and the second storage volume.

In examples where multiple storage topologies are employed, each entity of a computing environment can be associated with metadata containing a topology ID (or multiple topology IDs) specifying which storage topology (or storage topologies) is to be used when determining overlapping data protection policies.

In other examples, a single storage topology can be used to represent different subsets of entities, even if they are not associated with one another. This single storage topology may have multiple different segments that correspond to the different subsets of entities.

The data protection management system 102 can access the storage topology 108 to determine the different levels of entities capable of storing data for the purpose of detect overlapping data protection policies. A determination of whether overlapping data protection policies exist can be performed in the following contexts: (1) in response to a request to create a new data protection policy, or (2) in response to topology changes of a computing environment, such as due to migration of virtual compute entities such as VMs or containers.

The data protection management system 102 includes a protection recommendation engine 114 and a data protection scheduler 116. In some examples, the protection recommendation engine 114 and the data protection scheduler 116 can be implemented as machine-readable instructions executable by a processing resource of the data protection management system 102. The protection recommendation engine 114 and the data protection scheduler 116 may be implemented on different computers or on the same computer. In other examples, the protection recommendation engine 114 and the data protection scheduler 116 may be integrated into one control entity.

A policy requester 118 can issue a data protection policy request 120 to the protection recommendation engine 114. The policy requester 118 can be an electronic device or a program. The policy requester 118 can receive an input, such as from a user, specifying that a data protection policy is to be created for a given entity (or group of entities). In response to such an input, the policy requester 118 issues the data protection policy request 120 to the protection recommendation engine 114. Note that there may be other policy requesters that can issue respective data protection policy requests to the protection recommendation engine 114.

In response to the data protection policy request 120, the protection recommendation engine 114 can determine whether the requested data protection policy overlaps any of the data protection policies 104-1 to 104-N that already exist. If the protection recommendation engine 114 determines that there is no overlap of the requested data protection policy and the existing data protection policies 104-1 to 104-N, the protection recommendation engine 114 can create the data protection policy and add the requested data protection policy to the policy repository 106. The data protection policies 104-1 to 104-N may be identified by policy IDs.

If the protection recommendation engine 114 determines that an overlap exists between the requested data protection policy and the existing data protection policies 104-1 to 104-N, then the protection recommendation engine 114 creates a recommended action 122. Examples of recommended actions to address data protection policy overlaps are discussed further below.

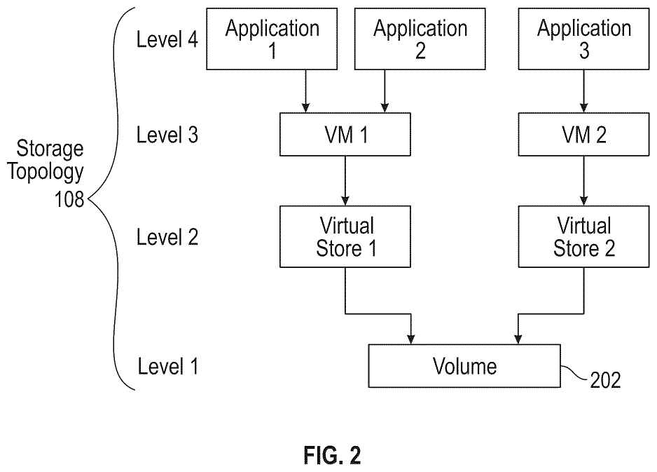

The determination of whether a first data protection policy for a first entity overlaps a second data protection policy for a second entity is based on a determination, according to a relationship of the first entity and the second entity in the storage topology 108, of whether the second data protection policy for the second entity offers either partial or full protection for the first entity. If the second data protection policy offers either partial or full protection for the first entity, then the protection recommendation engine 114 determines that an overlap exists between the first and second data protection policies. However, if the second data protection policy does not offer any protection for the first entity, then the protection recommendation engine 114 determines that no overlap exists between the first and second data protection policies. Some examples of overlaps of data protection policies are discussed further below in connection with FIGS. 2 to 9.

A topology change of the storage topology 108 may also cause previously non-overlapping data protection policies to overlap. For example, a migration of a VM may cause the VM to use a different storage volume. As another example, a container may be moved from one computing node to another computing node, which can cause the container to switch from using one storage volume to another storage volume. As a further example, an application program previously executed in a first VM or container may be moved to execute in a second VM or container.

The topology manager 110 can detect a topology change based on outputs from the inventory managers 112. In some examples, a topology refresh can be triggered in response to certain events, where the topology refresh includes the topology manager 110 obtaining updated outputs from the inventory managers 112 to detect any topology changes. A topology refresh can be performed on a periodic basis, for example. As further examples, a topology refresh can be performed in response to any or some combination of the following events: a recovery point is created, a failover occurs due to a fault in the computing environment, a movement of an entity such as an application program, a VM, or a container, a reassignment of an entity to a different group of entities, or any physical change in the topology of the computing environment.

In response to detecting a topology change, the topology manager 110 can issue a topology change indication 121 (e.g., a message, a signal, an information element, or any other indicator) to the protection recommendation engine 114. The topology manager 110 can also update the storage topology 108 to reflect the topology change. In response to the topology change indication 121, the protection recommendation engine 114 analyzes the data protection policies (e.g., 104-1 to 104-N) in the policy repository 106 to determine whether an overlap is detected among the data protection policies.

The data protection scheduler 116 issues data protection runs 124 based on the data protection policies 104-1 to 104-N in the policy repository 106. A data protection run 124 refers to a process for creating a recovery point, which can include a snapshot or a backup copy of data. As shown in FIG. 1, the data protection runs 124 produce recovery points 126. A snapshot can refer to a point-in-time copy of data, where the snapshot contains a copy of data that has changed since the last recovery point. A backup copy can refer to a full copy of data that exists at the time of creating the backup copy. The scheduling of data protection runs 124 by the data protection scheduler 116 is based on information included in the data protection policies 104-1 to 104-N regarding when to perform data duplications and what data to duplicate.

FIG. 2 shows an example of a simplified storage topology 108 that includes various entities. In the example, the storage topology 108 includes four levels: level 1 (the lowest level) including a storage volume 202; level 2 including virtual stores 1 and 2; level 3 including VMs 1 and 2; and level 4 including application programs 1, 2, and 3. In the example of FIG. 2, each of virtual stores 1 and 2 store data in the storage volume 202. In a different example, a virtual store can store data in multiple storage volumes at level 1. In the example, VM 1 stores data in virtual store 1, and VM 2 stores data in virtual store 2. In other examples, a VM can store data in multiple virtual stores, or multiple VMs can store data in the same virtual store.

Each entity represented in a storage topology may be associated with metadata including a policy ID that identifies a data protection policy applicable to the entity. Note that if an entity is not protected by a data protection policy, then the entity would be associated with an indicator (e.g., a null policy ID value) indicating that the entity is not protected by any data protection policy.

Application programs 1 and 2 are executed in VM 1, and application program 3 is executed in VM 2. Although specific quantities of entities are shown at each level in the storage topology 108, in other examples, a level of the storage topology 108 can store a different quantity of entities that shown in FIG. 2.

In different examples, other storage topologies can be used. In other storage topologies, one or more of the levels shown in FIG. 2 may be omitted. In further examples, storage topologies can include levels representing different types of entities.

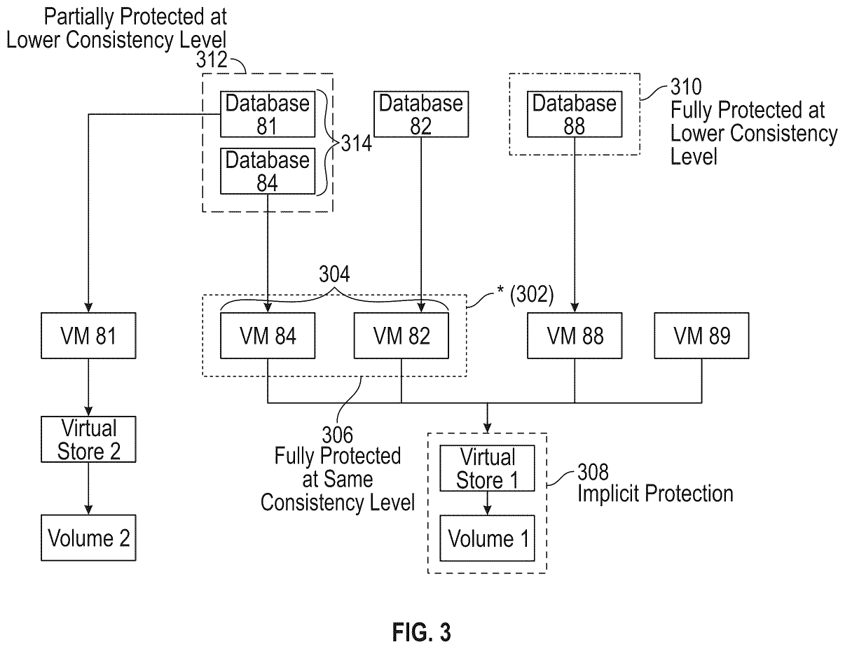

FIG. 3 is a block diagram of an example arrangement including entities at different levels of a storage topology that is similar to the storage topology 108. The example storage topology of FIG. 3 includes four levels: level 1 including storage volumes 1 and 2; level 2 including virtual stores 1 and 2; level 3 including VM 81, VM 84, VM 82, VM 88, and VM 89; and level 4 including database programs 81, 84, 82, and 88, which are examples of application programs. In the example, database program 81 executes in VM 81, database program 84 executes in VM 84, database program 82 executes in VM 82, and database program 88 executes in VM 88. VM 81 stores data in virtual store 2, and VMs 84, 82, 88, and 89 store data in virtual store 1. Virtual store 2 stores data in storage volume 2, and virtual store 1 stores data in storage volume 1.

In FIG. 3, an * represents an existing data protection policy 302 for a VM group 304 that includes VM 84 and VM 82. As used here, an “existing” data protection policy can refer to a data protection policy that has already been created for a given entity, which in this case is the VM group 304. The existing data protection policy 302 specifies that data of VM 84 and VM 82 is to be protected by creating recovery points according to a duplication rule included in the existing data protection policy 302. It is assumed that there are no other existing data protection policies for other entities shown in FIG. 3.

The following discusses three example requests for creating data protection policies for different entities of the storage topology of FIG. 3. The requests are received after the existing data protection policy 302 is already in place.

A first example request is for creating a data protection policy for VM 82 (after the existing data protection policy 302 is already in place for the VM protection group 304). Note that VM 82 is a member of the VM group 304. In response to the first request, the protection recommendation engine 114 can determine that VM 82 is fully protected at the same consistency level (306) based on the existing data protection policy 302 for the VM group 304. The full protection is determined based on VM 82 being part of the VM group 304 that is already protected by the existing data protection policy 302. The full protection of VM 82 is a direct protection of VM 82 by virtue of the protection of the VM group 304.

As used here, a “consistency level” of protection refers to the level of a storage topology at which data protection is offered. The existing data protection policy 302 protects the VM group 304 at the VM consistency level, i.e., data specific to one or more VMs is duplicated when creating a recovery point.

Because VM 82 is already fully protected at the same consistency level, the protection recommendation engine 114 can deny the first example request to create the data protection policy for VM 82. The denial of the first example request is an example of a recommended action 122 (FIG. 1). In some examples, the protection recommendation engine 114 can send a notification of the denial of the first request to a policy requester (e.g., 118 in FIG. 1), where the notification indicates that the first example request has been denied and the reason for the denial. In another example, the protection recommendation engine 114 can trigger another recommended action 122, which includes creating the protection policy for VM 82 and sending an alert to the policy requester 118 indicating the presence of the overlapping data protection policies.

A second example request is for creating a data protection policy for database program 88. Note that because of the existing data protection policy 302 for the VM group 304, implicit (indirect) data protection (308) exists for each of virtual store 1 and storage volume 1. To protect an entity at a high level (in this case VMs 84 and 82), a data store at a lower level (in this case virtual store 1) is implicitly (indirectly) protected. Similarly, because of the implicit protection of virtual store 1, implicit protection exists for storage volume 1. Stated differently, data of VMs 84 and 82 is stored in virtual store 1 and storage volume 1. To be able to protect the data of VMs 84 and 82, the data of virtual store 1 and storage volume 1 is duplicated.

Because virtual store 1 is implicitly protected, database program 88 is also fully protected (indirectly) but at a lower consistency level (310). The lower consistency level is the virtual store consistency level. The full protection at the lower consistency level is determined based on the protection recommendation engine 114 detecting a relationship between database program 88 and virtual store 1, i.e., database program 88 executes in VM 88 that stores data in virtual store 1.

The protection of database program 88 at the lower consistency level means that although the data written by database program 88 is not lost in case of database program 88 crashing. However, because a recovery point was not created specifically for database program 88 (i.e., no protection exists for database program 88 at the application consistency level), it may not be possible to recover a state of database program 88 after database program 88 crashes. Recovering a state of an entity can refer to recovering the data in use by the entity at the time the entity crashed.

More generally, indirectly protecting an entity (in level j of a storage topology) at a lower consistency level (e.g., level k of the storage topology, where k<j) means that the data of the entity will not be lost, but the state of the entity may not be recoverable. On the other hand, indirectly protecting a first entity (in level j of the storage topology) at a higher consistency level (e.g., level i of the storage topology, where i>j) means that all data of the first entity in level j is also protected, along with protection of the second entity in level i of the storage topology.

In some examples, in response to detecting that database program 88 is fully protected at a lower consistency level (310), the protection recommendation engine 114 can trigger a recommended action 122 that includes creating the data protection policy for database program 88, especially if an indication is received (such as with the second example request) that the creation of the data protection policy for database program 88 is relatively important.

In further examples, the protection recommendation engine 114 may trigger another recommended action 122 that includes removing a data protection policy at a lower level. For example, if an existing data protection policy exists for virtual store 1, then after the protection recommendation engine 114 creates the data protection policy for database program 88, the protection recommendation engine 114 can remove the existing data protection policy exists for virtual store 1. The protection recommendation engine 114 can notify the data protection scheduler 116 of the decision to remove the existing data protection policy exists for virtual store 1. In response to this notification, the data protection scheduler 116 can suspend the scheduling of any further data protection runs 124 for the existing data protection policy exists for virtual store 1.

A third example request is for creating a data protection policy for an application group 314 including database programs 81 and 84. Although database program 84 executes in VM 84 that is protected by the existing data protection policy 302, database program 81 executes in VM 81 that is not protected by any data protection policy. As a result, the protection recommendation engine 114 determines that the application group 314 is partially protected (indirectly) at a lower consistency level (312).

In some examples, the protection recommendation engine 114 can trigger a recommended action 122 that includes moving database program 81 out of the application group 314 so that the application group 314 includes just database program 84. Database program 81 can be assigned to another application group. As a result of the change of the application group 314, data for the application group 314 is fully protected at a lower consistency level. Another recommended action 122 that can be triggered by the protection recommendation engine 114 includes creating a data different production policy for VM 81 so that data of database program 81 is also protected at the VM consistency level. As yet another example, the recommended action 122 triggered by the protection recommendation engine 114 can include moving VM 81 into the VM group 304, so that the existing data protection policy 302 now covers data of VMs 81, 84, and 82. As a result, the application group 314 would be fully protected at a lower consistency level (the VM consistency level).

More generally, entity X in first level j is indirectly protected by a data protection policy for entity Y in second level k (k≠j) if entity X has a data interaction relationship with entity Y. A “data interaction relationship” refers to a relationship in which a data write performed by a first entity involves a second entity. For example, if entity Y is a VM or a container, entity X can be an application program executing in entity Y, and thus data writing actions by entity X occur in entity Y. As another example, if entity Y is a storage volume, entity X can be a VM/container/application program that writes data to entity Y. As a further example, entity X can be a storage volume, and entity Y writes data to entity X.

In FIG. 3, database program 82 is fully protected (indirectly) at a lower consistency level by virtue of the existing data protection policy 302. Similarly, VM 88 is fully protected (indirectly) at a higher consistency level by virtue of the implicit data protection (308) of virtual store 1.

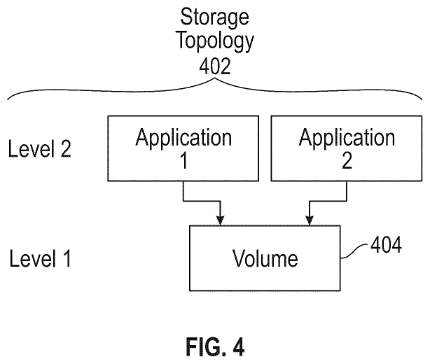

FIG. 4 shows another example simplified storage topology 402 that has two levels: level 1 including a storage volume 404; and level 2 including application program 1 and application program 2. The application programs 1 and 2 store data in the storage volume 404. Unlike the storage topologies of FIG. 2 and FIG. 3, virtualized entities (such as VMs and virtual stores) are not part of the storage topology 402.

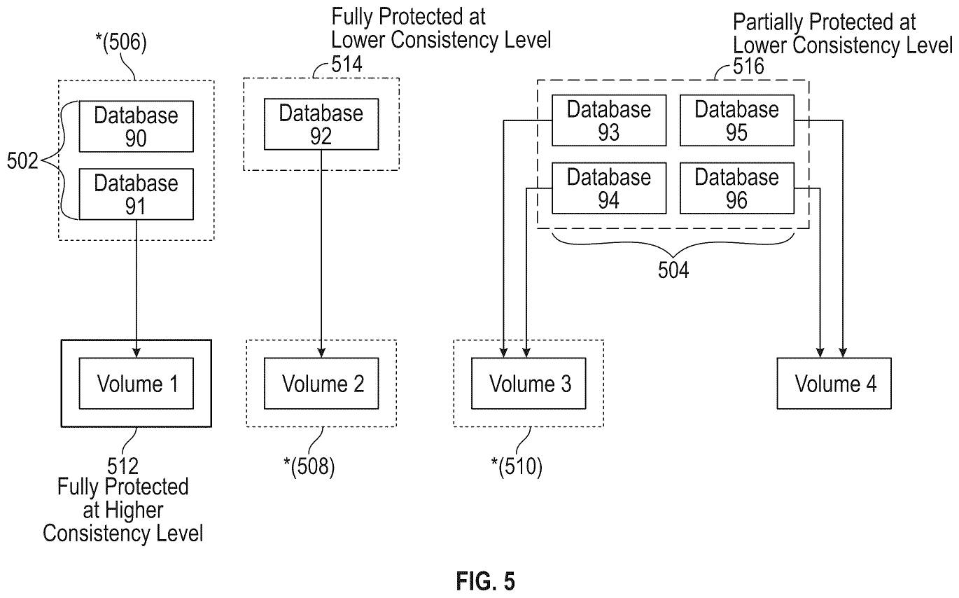

FIG. 5 is a block diagram of an example arrangement including entities at different levels of a storage topology that is similar to the storage topology 402. The example storage topology of FIG. 5 includes two levels: level 1 including storage volumes 1, 2, 3, and 4; and level 2 including database programs 90, 91, 92, 93, 94, 95, and 96.

Database programs 90 and 91 are part of an application group 502, and database programs 90 and 91 store data in storage volume 1. Database program 92 stores the data in storage volume 2. Database programs 93 and 94 store data in storage volume 3, and database programs 95 and 86 store data in storage volume 4. Database programs 93, 94, 95, 96 are part of an application group 504.

Three instances of * in FIG. 5 represent three existing data protection policies, including an existing data protection policy 506 that protects data of application group 502, an existing data protection policy 508 that protects data of storage volume 2, and an existing data protection policy 510 that protects data of storage volume 3. It is assumed that there are no other existing data protection policies for other entities shown in FIG. 5.

In FIG. 5, a first example request is for creating a data protection policy for storage volume 1. The protection recommendation engine 114 determines that the requested data protection policy overlaps the existing data protection policy 506 since storage volume 1 is fully protected by the existing data protection policy 506 at a higher consistency level (512), which in this case is the application consistency level. As a result, the protection recommendation engine 114 can trigger a recommended action 122 including denying the first example request to create the data protection policy for storage volume 1.

A second example request is for creating a data protection policy for database program 92. Because of the existing data protection policy 508 for storage volume 2, the protection recommendation engine 114 determines that data of database program 92 is fully protected at a lower consistency level (514), which in this case is the storage volume consistency level. The protection recommendation engine 114 can trigger a recommended action 122 including creating the data protection policy for database program 92, especially if an indication is received (such as with the second example request) that the creation of the data protection policy for database program 92 is relatively important. As another example, the recommended action 122 may further include removing the existing data protection policy 508 for storage volume 2.

A third example request is for creating a data protection policy for the application group 504 that includes database programs 93, 94, 95, and 96. Because of the existing data protection policy 510, the protection recommendation engine 114 determines that the application group 504 is partially protected at a lower consistency level 516. The protection recommendation engine 114 can trigger a recommended action 122 to address the partial protection, similar to any of those discussed above in connection with FIG. 3.

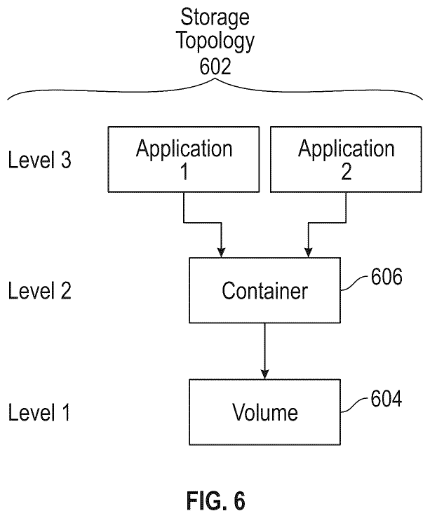

FIG. 6 shows another example simplified storage topology 602, which has three levels: level 1 including a storage volume 604; level 2 including a container 606; and level 3 including application programs 1 and 2 that execute in the container 606

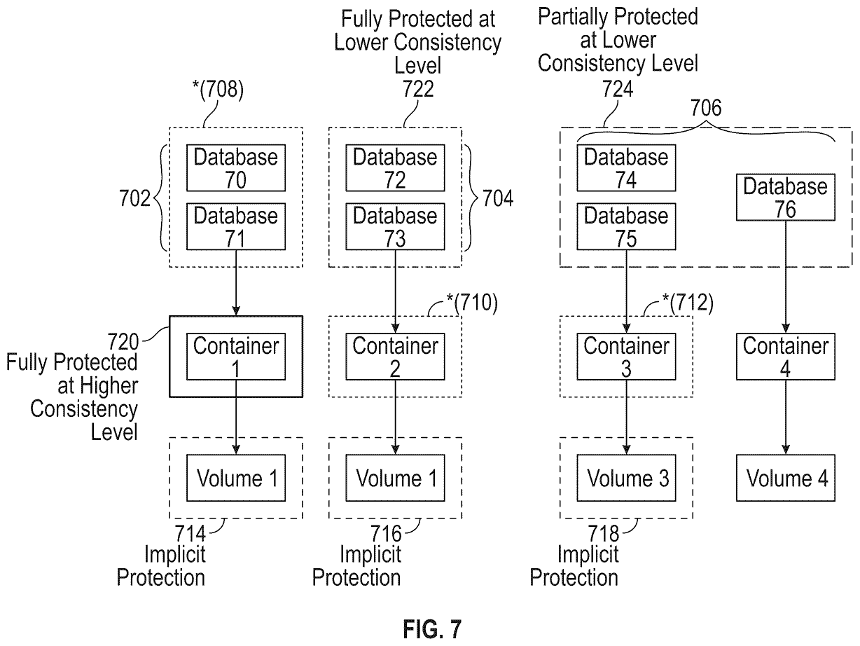

FIG. 7 a block diagram of an example arrangement including entities at different levels of a storage topology that is similar to the storage topology 602. The example storage topology of FIG. 7 includes three levels: level 1 including storage volumes 1, 2, 3, and 4; level 2 including containers 1, 2, 3, and 4; and level 3 including database programs 70, 71, 72, 73, 74, 75, and 76.

Database programs 70 and 71 are part of an application group 702, and database programs 70 and 71 execute in container 1. Container 1 stores data in storage volume 1. Database programs 72 and 73 are part of an application group 704, and database programs 72 and 73 execute in container 2. Container 2 stores data in storage volume 2. Database programs 74, 75, and 76 are part of an application group 706. Database programs 74 and 75 execute in container 3, and database program 76 execute in container 4. Container 3 stores data in storage volume 3, and container 4 stores data in storage volume 4.

Three instances of * in FIG. 7 represent three existing data protection policies, including an existing data protection policy 708 that protects data of the application group 702, an existing data protection policy 710 that protects data of container 2, and an existing data protection policy 712 that protects data of container 3.

Because of the existing data protection policy 708 for the application group 702, an implicit data protection 714 exists for storage volume 1. Similarly, because of the existing data protection policy 710 for container 2, an implicit data protection 716 exists for storage volume 2. Similarly, because of the existing data protection policy 712 protects container 3, an implicit data protection 718 exists for storage volume 3.

In FIG. 7, a first example request is for creating a data protection policy for container 1. Because of the existing data protection policy 708 for the application group 702 that includes database programs 70 and 71 that execute in container 1, the existing data protection policy 708 fully protects container 1 at a higher consistency level (720).

A second example request is for creating a data protection policy for the application group 704. Because of the existing data protection policy 710 for container 2, the protection recommendation engine 114 determines that the application group 704 is fully protected at a lower consistency level (722), which in this case is the container consistency level.

A third example request is for creating a data protection policy for the application group 706. Because the existing data protection policy 712 protects container 3, but no existing data protection policy protects container 4, the protection recommendation engine 114 determines that the application group 706 is partially protected by the existing data protection policy 712 at a lower consistency level (724).

The protection recommendation engine 114 can trigger respective recommended actions 122 for the first, second, and third example requests for FIG. 7. The triggered recommended actions 122 can be similar to those discussed above in connection with FIG. 3 or 5.

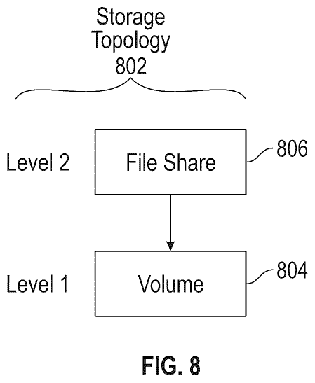

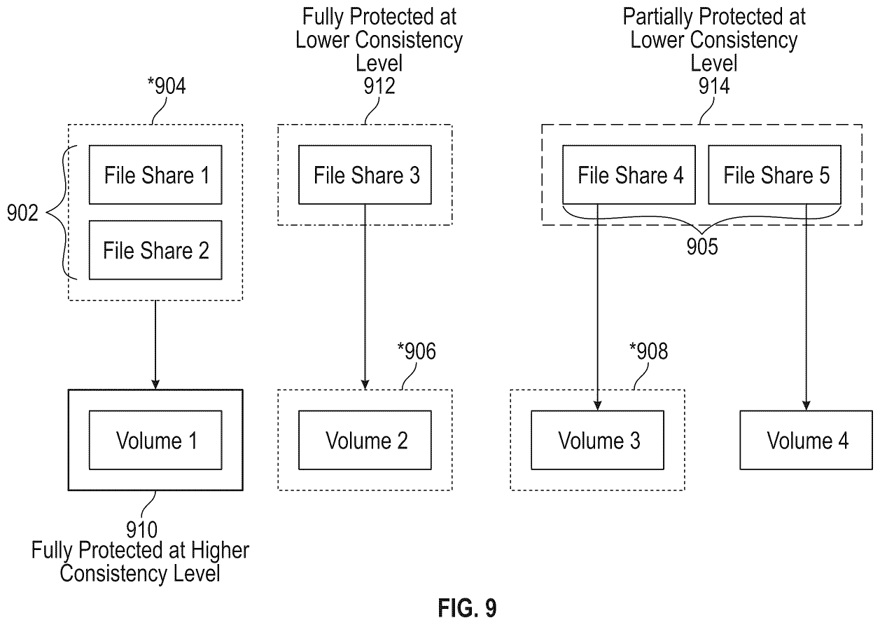

FIG. 8 shows another example simplified storage topology 802 that includes two levels: level 1 including storage volume 804; and level 2 including file share 806. A “file share” can refer to a logical share or a mount point (e.g., a network attached storage or NAS mount point) of an underlying filesystem. The example storage topology of FIG. 9 includes two levels: level 1 including storage volumes 1, 2, 3, and 4; and level 2 including file shares 1, 2, 3, 4, and 5.

File shares 1 and 2 are part of a file share group 902, and store data in storage volume 1. File share 3 stores data in storage volume 2. File share 4 stores data in storage volume 3, and file share 5 stores data in storage volume 4. File shares 4 and 5 are part of a file share group 905.

Three instances of * in FIG. 9 represent three existing data protection policies, including an existing data protection policy 904 that protects data of the file share group 902 including file shares 1 and 2, an existing data protection policy 906 that protects data of storage volume 2, and an existing data protection policy 908 that protects data of storage volume 3.

In FIG. 9, a first example request is for creating a data protection policy for storage volume 1. Because of the existing data protection policy 904, storage volume 1 is fully protected at a higher consistency level (910), which is the file share consistency level.

A second example request is for creating a data protection policy for file share 3. Because of the existing data protection policy 906 for storage volume 2, file share 3 is fully protected at a lower consistency level (912) by the existing data protection policy 906.

A third example request is for creating a data protection policy for file share group 905 including file shares 4 and 5. Because of the existing data protection policy 908 for storage volume 3, and because of the lack of a data protection policy for storage volume 4, the protection recommendation engine 114 determines that the file share group 905 is partially protected at a lower consistency level (914) by the existing data protection policy 908.

The protection recommendation engine 114 can trigger respective recommended actions 122 for the first, second, and third example requests for FIG. 9. The triggered recommended actions 122 can be similar to those discussed above in connection with FIG. 3 or 5.

As noted above, a topology change of a storage topology, as detected by the topology manager 110 of FIG. 1, for example, may cause existing data protection policies to overlap. For example, in FIG. 9, it is assumed that a further existing data protection policy protects data of storage volume 4. Container 2 may run in a first computing node that includes storage volume 2, and container 4 may run a different second computing node that includes storage volume 4. Container 2 may be migrated from the first computing node to the second computing node for any of various reasons, such as at the request of a user, to balance workload, as part of failover due to faults being experienced at the first computing node, or for any other reason.

Once container 2 is moved to the second computing node, container 2 may store data in storage volume 4 instead of storage volume 2. As a result of the migration of container 2, the existing data protection policy 710 and the further existing data protection policy 712 for storage volume 4 overlap. In response to detecting this overlap as a result of the above topology change, the protection recommendation engine 114 can trigger a recommended action 122, which may include removing the further existing data protection policy 712 for storage volume 4.

Each recovery point 126 (FIG. 1) created as a result of a data protection run 124 is tagged with metadata including a topology ID of the storage topology that is applicable at the time of creation of the recovery point 126. Note that the topology of a computing environment may be continually changing, so that storage topologies may change over time.

Associating storage topologies with recovery points allows a history of storage topologies to be maintained and can allow an analyst to understand storage topology differences associated with different recovery points created at different times. The topology differences may be used by the analyst to determine what actions to take when using recovery points to recover data.

In accordance with some examples of the present disclosure, the ability to detect overlapping data protection policies and to take recommended actions in response to the detected overlaps can reduce data duplication sprawl in a computing environment. Reducing data duplication sprawl can refer to reducing redundant instances of duplications of data items caused by applying overlapping data protection policies. Reducing redundant duplications of data items increases the deduplication ratio of stored data in the computing environment, and enhances the efficiency in storage resource usage.

Detecting overlapping data protection policies can allow a system to: (1) avoid creating a new data protection policy where an existing data protection policy already offers data protection for an entity in a storage topology, or (2) remove one or more of the overlapping data protection policies. By reducing the number of data protection policies in the computing environment, the quantity of recovery points created based on applying data protection policies is reduced.

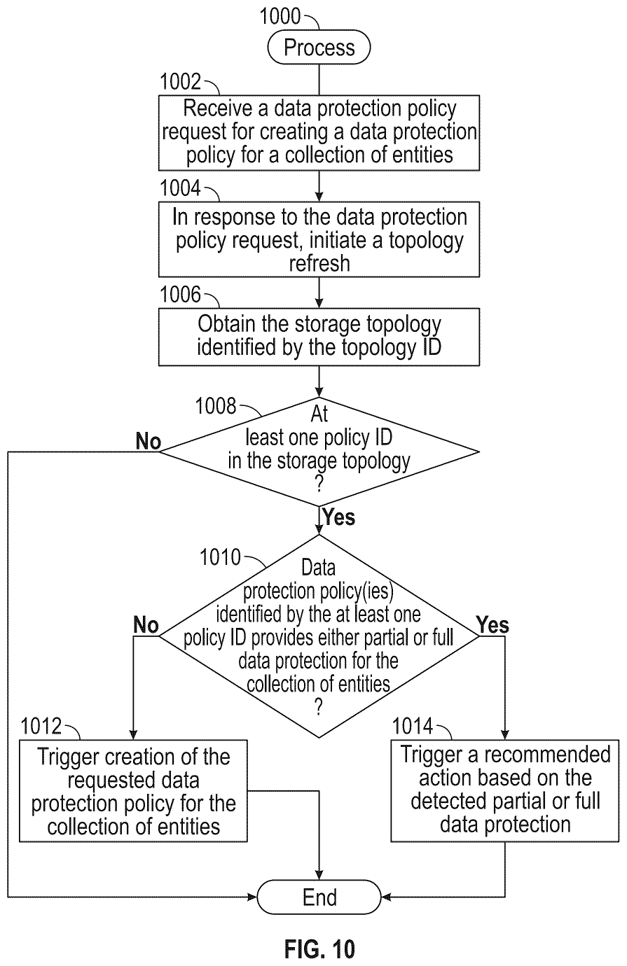

FIG. 10 is a flow diagram of a process 1000 according to some examples, which may be performed by the protection recommendation engine 114 of FIG. 1, for example. The protection recommendation engine 114 receives (at 1002) a data protection policy request for creating a data protection policy for a collection of entities, which can include a single entity or multiple entities. The data protection policy request can include an entity ID of each entity in the collection of entities.

In response to the data protection policy request, the protection recommendation engine 114 initiates (at 1004) a topology refresh that would cause any storage topologies stored in a policy repository (e.g., 106 in FIG. 1) to be updated if appropriate. An entity of the collection of entities may be associated with metadata including a topology ID that identifies a storage topology that the entity is part of. Note that the entities of the collection of entities may be associated with multiple storage topologies, in which case multiple topology IDs would be associated with the collection of entities. In the ensuing discussion, it is assumed that there is just one topology ID identifying a storage topology. If there are multiple topology IDs, then the ensuing process can be iterated for each of the respective multiple storage topologies.

The protection recommendation engine 114 obtains (at 1006) the storage topology identified by the topology ID. If any entity in the storage topology is protected by a data protection policy, the storage topology can include metadata including a policy ID of the data protection policy.

The protection recommendation engine 114 determines (at 1008) whether at least one policy ID is included in the storage topology. No policy ID included in the storage topology means that there is no data protection policy associated with any entity in the storage topology. In this case (the “No” path of the decision block 1008), no further action is taken and the process 1000 ends.

However, if the protection recommendation engine 114 determines (at 1008) that at least one policy ID is included in the storage topology, the protection recommendation engine 114 determines (at 1010) whether the data protection policy (or policies) identified by the at least one policy ID provides either partial or full data protection for the collection of entities. If not, then the protection recommendation engine 114 can trigger (at 1012) creation of the requested data protection policy for the collection of entities. However, if the protection recommendation engine 114 determines (at 1010) that the data protection policy (or policies) identified by the at least one policy ID provides either partial or full data protection for the collection of entities, the protection recommendation engine 114 triggers (at 1014) a recommended action based on the detected partial or full data protection.

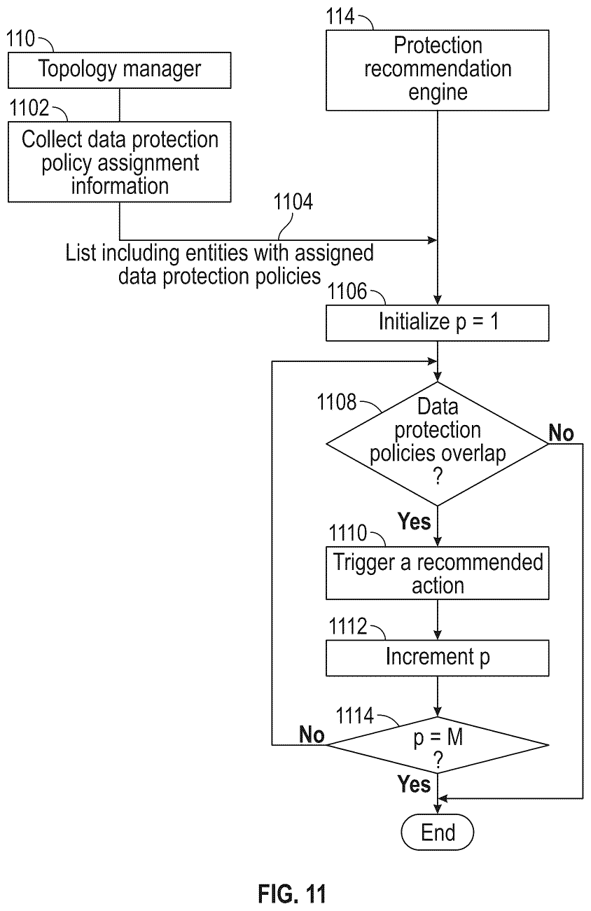

FIG. 11 is a flow diagram of a process according to some examples. The process of FIG. 11 involves the topology manager 110 and the protection recommendation engine 114. In some examples, on a periodic basis (e.g., every 24 hours or some other interval), the topology manager 110 (FIG. 1) can collect (at 1102) data protection policy assignment information that associates data protection policies with respective entities in a computing environment. The topology manager 110 provides (at 1104) to the protection recommendation engine 114 a list including the entities with assigned data protection policies (as identified by respective policy IDs). The list can be provided as part of a request to check for overlapping data protection policies.

In response, the protection recommendation engine 114 iterates through storage topologies 1 to M (M≥1) for the entities in the list from the topology manager 110. The entities in the list may be part of multiple storage topologies in some examples.

The protection recommendation engine 114 initializes (at 1106) a topology count p to 1 to start the iteration with storage topology p (which is a member of storage topologies 1 to M). The protection recommendation engine 114 determines (at 1108) whether a data protection policy (or policies) identified by at least one policy ID in storage topology p overlaps at least one other data protection policy. If not, then no further action is taken by the protection recommendation engine 114. However, if the protection recommendation engine 114 determines (at 1108) that the data protection policy (or policies) identified by the at least one policy ID in storage topology p overlaps at least one other data protection policy, the protection recommendation engine 114 triggers (at 1110) a recommended action based on the detected overlap.

After incrementing (at 1112) topology count p, the protection recommendation engine 114 determines (at 1114) if p is equal M. If not, the protection recommendation engine 114 iterates through tasks 1108 to 1112 for the next storage topology p. If p is equal M, then the process ends.

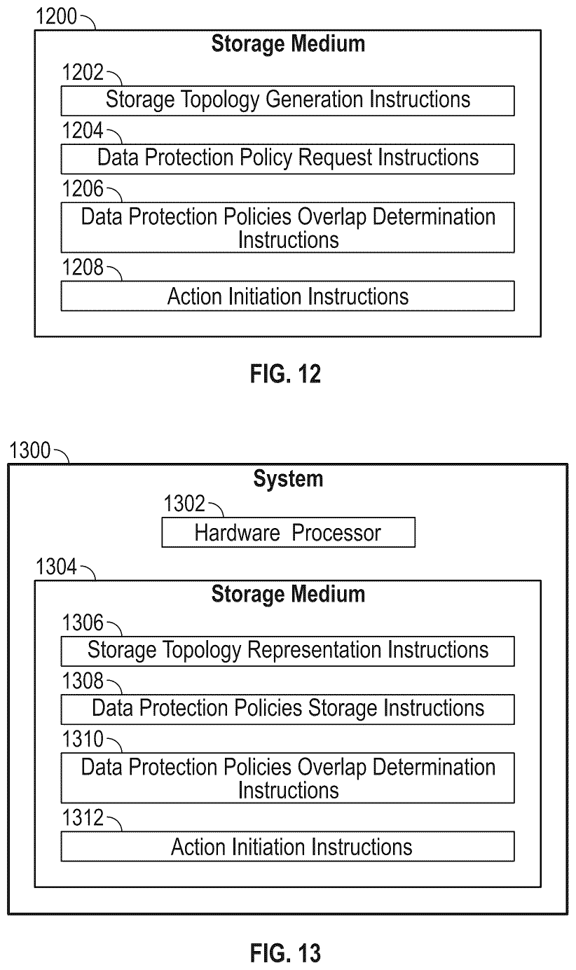

FIG. 12 is a block diagram of a non-transitory machine-readable or computer-readable storage medium 1200 storing machine-readable instructions that upon execution cause a system to perform various tasks. The system may include one or more computers.

The machine-readable instructions include storage topology generation instructions 1202 to generate a representation of a storage topology including a plurality of levels of entities that store data in a computing environment. The plurality of levels of entities include a first level including storage volumes and a second level including entities that request storage of data in the storage volumes. Examples of the entities include application programs, VMs, containers, file shares, or other entities. There may be ore than two levels in the storage topology. An entity may also include a group of entities, which is referred to as a “data protection group.” Examples of data protection groups include a VM group, an application program group, a file share group, a container group, or any other group.

The machine-readable instructions include data protection policy request instructions 1204 to receive a request to add a first data protection policy for a first entity that is a member of the plurality of levels of entities. The first data protection policy specifies duplication of first data for the first entity, such as by creating a recovery point.

The machine-readable instructions include data protection policies overlap determination instructions 1206 to determine, based on the representation of the storage topology, whether an overlap exists between the first data protection policy and a second data protection policy for a second entity that is a member of the plurality of levels of entities.

The machine-readable instructions include action initiation instructions 1208 to, based on determining that the overlap exists between the first data protection policy and the second data protection policy, initiate an action to reduce data duplication sprawl. Reducing data duplication sprawl may be accomplished by making a change associated with the first and second data protection policies or making a change associated with an entity in the computing environment.

In some examples, making the change associated with the first and second data protection policies includes removing the first data protection policy or the second data protection policy. For example, a data protection policy at a lower consistency level may be removed.

In some examples, making the change associated with the entity in the computing environment includes one or more of: suspending creation of a recovery point for the entity, re-assigning the entity to a different data protection group, or moving the entity (e.g., to a different computing node or to a different virtual store). Moving an entity from a first computing node to a second computing node includes removing an instance of the entity on the first computing node and starting an instance of the entity on the second computing node. Moving the entity from a first virtual store to a second virtual store includes changing an assignment of virtual stores such that the entity uses the second virtual store instead of the first virtual store after the re-assignment.

In some examples, the machine-readable instructions can receive information of the entities in the plurality of levels of entities from one or more inventory managers (e.g., 112 in FIG. 1) that manage inventories of entities. The machine-readable instructions can generate the representation of the storage topology based on the received information.

In some examples, the generating of the representation of the storage topology includes identifying which entities use which storage volumes, and/or which entities execute in other entities.

In some examples, the plurality of levels of entities further includes a third level including an entity that requests storage of data in a storage volume of the storage volumes, the entity in the third level to execute within a given entity in the second level. The generating of the representation of the storage topology includes identifying the given entity in which the entity in the third level executes.

In some examples, the overlap between the first data protection policy and the second data protection policy is based on the second data protection policy specifying duplication of second data for the second entity where the second data overlaps with the first data for the first entity.

In some examples, the machine-readable instructions can detect a topology change that results in a changed arrangement of entities in the plurality of levels of entities, and generate an updated representation of the storage topology based on the topology change. The machine-readable instructions can identify a given data protection policy for a given entity that is a member of the of the plurality of levels of entities after the topology change, and determine, based on the updated representation of the storage topology, whether an overlap exists between the given data protection policy and a further data protection policy for another entity that is a member of the plurality of levels of entities after the topology change. Based on determining that the overlap exists between the given data protection policy and the further data protection policy, the machine-readable instructions can initiate a further action to reduce data duplication sprawl.

In some examples, the topology change is identified in a topology refresh triggered based on any one or more of: a creation of a recovery point, a failover of an entity, a movement of an entity, a change in assignment of an entity to a group, or a change in a physical topology of the computing environment.

FIG. 13 is a block diagram of a system 1300 including a hardware processor 1302 (or multiple hardware processors). A hardware processor can include a microprocessor, a core of a multi-core microprocessor, a microcontroller, a programmable integrated circuit, a programmable gate array, or another hardware processing circuit.

The system 1300 includes a storage medium 1304 storing machine-readable instructions executable on the hardware processor 1302 to perform various tasks. Machine-readable instructions executable on a hardware processor can refer to the instructions executable on a single hardware processor or the instructions executable on multiple hardware processors.

The machine-readable instructions in the storage medium 1304 include storage topology representation instructions 1306 to provide a representation of a storage topology including a plurality of levels of entities that store data in a computing environment. The plurality of levels of entities includes a first level including storage volumes and a second level including entities that request storage of data in the storage volumes.

The machine-readable instructions in the storage medium 1304 include data protection policies storage instructions 1308 to store, in a policy repository, data protection policies for respective entities in the computing environment.

The machine-readable instructions in the storage medium 1304 include data protection policies overlap determination instructions 1310 to determine, based on the representation of the storage topology, whether an overlap exists between a first data protection policy and any of the data protection policies in the policy repository.

The machine-readable instructions in the storage medium 1304 include action initiation instructions 1312 to, based on determining that the overlap exists between the first data protection policy and a second data protection policy in the policy repository, initiate an action including making a change associated with the first and second data protection policies or making a change associated with an entity in the computing environment.

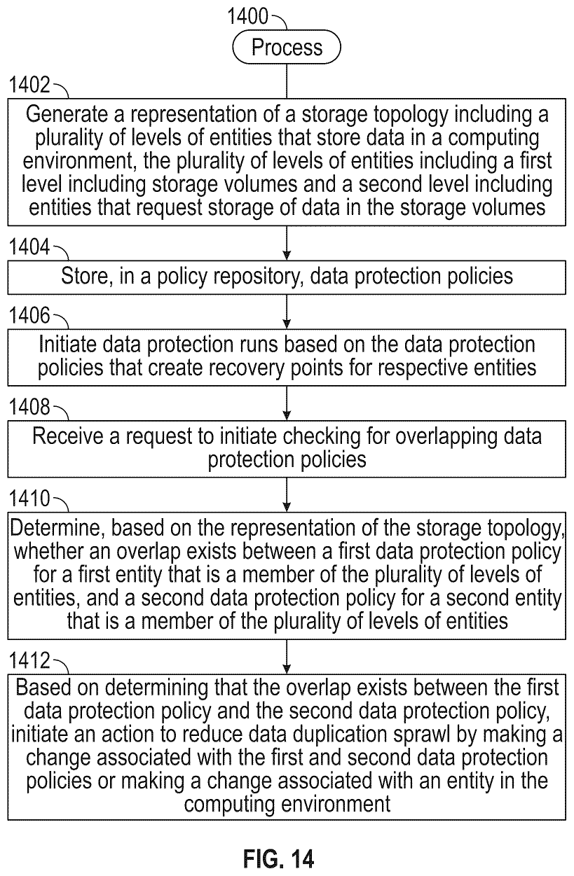

FIG. 14 is a flow diagram of a process 1400 according to some examples. The process 1400 may be performed by the data protection management system 102 of FIG. 1, for example.

The process 1400 includes generating (at 1402) a representation of a storage topology including a plurality of levels of entities that store data in a computing environment, the plurality of levels of entities including a first level including storage volumes and a second level including entities that request storage of data in the storage volumes. Note that there may be multiple storage topologies for different subsets of entities in the computing environment.

The process 1400 includes storing (at 1404), in a policy repository, data protection policies. An example of the policy repository is the policy repository 106 of FIG. 1.

The process 1400 includes initiating (at 1406) data protection runs based on the data protection policies that create recovery points for respective entities. The data protection runs may be initiated by the data protection scheduler 116 of FIG. 1, for example.

The process 1400 includes receiving (at 1408) a request to initiate checking for overlapping data protection policies. The request includes one of: a request to add the first data protection policy for the first entity, or a request based on an event in the computing environment (such as an event that triggers a topology refresh).

The process 1400 includes determining (at 1410), based on the representation of the storage topology, whether an overlap exists between a first data protection policy for a first entity that is a member of the plurality of levels of entities, and a second data protection policy for a second entity that is a member of the plurality of levels of entities.

Based on determining that the overlap exists between the first data protection policy and the second data protection policy, the process 1400 includes initiating (at 1412) an action to reduce data duplication sprawl by making a change associated with the first and second data protection policies or making a change associated with an entity in the computing environment.

As used here, an “electronic device” can refer to any one or more of a desktop computer, a notebook computer, a tablet computer, a smartphone, a game appliance, and Internet-of-Things (IoT) device, a household appliance, a storage system, a communication node, a vehicle, or any other electronic device.

A “processing resource” can include one or more hardware processors.

A storage medium (e.g., 1200 in FIG. 12 or 1304 in FIG. 13) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
generate a representation of a storage topology comprising a plurality of levels of entities that store data in a computing environment, the plurality of levels of entities comprising a first level including storage volumes and a second level including entities that request storage of data in the storage volumes;
receive a request to add a first data protection policy for a first entity that is a member of the plurality of levels of entities, the first data protection policy specifying duplication of first data for the first entity;
determine, based on the representation of the storage topology, whether an overlap exists between the first data protection policy and a second data protection policy for a second entity that is a member of the plurality of levels of entities; and
based on determining that the overlap exists between the first data protection policy and the second data protection policy, initiate an action to reduce data duplication sprawl.

2. The non-transitory machine-readable storage medium of claim 1, wherein the instructions upon execution cause the system to:
receive information of the entities in the plurality of levels of entities from one or more inventory managers that manage inventories of entities; and
generate the representation of the storage topology based on the received information.

3. The non-transitory machine-readable storage medium of claim 2, wherein the generating of the representation of the storage topology comprises identifying which entities use which storage volumes.

4. The non-transitory machine-readable storage medium of claim 3, wherein the plurality of levels of entities further comprises a third level including an entity that requests storage of data in a storage volume of the storage volumes, the entity in the third level to execute within a given entity in the second level, wherein the generating of the representation of the storage topology comprises identifying the given entity in which the entity in the third level executes.

5. The non-transitory machine-readable storage medium of claim 4, wherein the entity in the third level comprises an application program, and the given entity in the second level comprises a virtual compute entity.

6. The non-transitory machine-readable storage medium of claim 1, wherein the plurality of levels of entities further comprises a third level including a virtual store that includes one or more storage volumes in the first level.

7. The non-transitory machine-readable storage medium of claim 1, wherein the entities in the second level comprise application programs, file shares, or virtual compute entities.

8. The non-transitory machine-readable storage medium of claim 1, wherein the overlap between the first data protection policy and the second data protection policy is based on the second data protection policy specifying duplication of second data for the second entity wherein the second data overlaps with the first data for the first entity.

9. The non-transitory machine-readable storage medium of claim 8, wherein the second data protection policy fully protects the first data for the first entity.

10. The non-transitory machine-readable storage medium of claim 9, wherein the second data protection policy fully protects the first data for the first entity at a same consistency level of the first entity.

11. The non-transitory machine-readable storage medium of claim 9, wherein the second data protection policy fully protects the first data for the first entity at a different consistency level.

12. The non-transitory machine-readable storage medium of claim 8, wherein the second data protection policy partially protects the first data for the first entity.

13. The non-transitory machine-readable storage medium of claim 1, wherein the instructions upon execution cause the system to:
detect a topology change that results in a changed arrangement of entities in the plurality of levels of entities;
generate an updated representation of the storage topology based on the topology change;
identify a given data protection policy for a given entity that is a member of the of the plurality of levels of entities after the topology change;
determine, based on the updated representation of the storage topology, whether an overlap exists between the given data protection policy and a further data protection policy for another entity that is a member of the plurality of levels of entities after the topology change; and
based on determining that the overlap exists between the given data protection policy and the further data protection policy, initiate a further action to reduce data duplication sprawl.

14. The non-transitory machine-readable storage medium of claim 13, wherein the topology change is identified in a topology refresh triggered based on any one or more of:
a creation of a recovery point,
a failover of an entity,
a movement of an entity,
a change in assignment of an entity to a group, or
a change in a physical topology of the computing environment.

15. A system comprising:
a hardware processor; and
a non-transitory storage medium storing instructions executable on the hardware processor to:
provide a representation of a storage topology comprising a plurality of levels of entities that store data in a computing environment, the plurality of levels of entities comprising a first level including storage volumes and a second level including entities that request storage of data in the storage volumes;
store, in a policy repository, data protection policies for respective entities in the computing environment;
determine, based on the representation of the storage topology, whether an overlap exists between a first data protection policy and any of the data protection policies in the policy repository; and
based on determining that the overlap exists between the first data protection policy and a second data protection policy in the policy repository, initiate an action including making a change associated with the first and second data protection policies or making a change associated with an entity in the computing environment.

16. The system of claim 15, wherein making the change associated with the first and second data protection policies comprises removing the first data protection policy or the second data protection policy.

17. The system of claim 15, wherein making the change associated with the entity in the computing environment comprises one or more of: suspending creation of a recovery point for the entity, re-assigning the entity to a different data protection group, or moving the entity.

18. The system of claim 15, wherein the entities in the second level comprise virtual compute entities, and wherein the plurality of levels of entities further comprises a third level including application programs that run in the virtual compute entities.

19. A method comprising:
generating, by a system comprising a hardware processor, a representation of a storage topology comprising a plurality of levels of entities that store data in a computing environment, the plurality of levels of entities comprising a first level including storage volumes and a second level including entities that request storage of data in the storage volumes;
storing, in a policy repository, data protection policies;
initiating, by the system, data protection runs based on the data protection policies that create recovery points for respective entities;
receiving, by the system, a request to initiate checking for overlapping data protection policies;
determining, by the system based on the representation of the storage topology, whether an overlap exists between a first data protection policy for a first entity that is a member of the plurality of levels of entities, and a second data protection policy for a second entity that is a member of the plurality of levels of entities; and
based on determining that the overlap exists between the first data protection policy and the second data protection policy, initiating, by the system, an action to reduce data duplication sprawl by making a change associated with the first and second data protection policies or making a change associated with an entity in the computing environment.

20. The method of claim 19, wherein the request comprises one of:
a request to add the first data protection policy for the first entity, or
a request based on an event in the computing environment.
